(19) United States
(12) Patent Application Publication
(10) Pub. No.: US 2020/0067985 A1
(43) Pub. Date: Feb. 27, 2020

(54) SYSTEMS AND METHODS OF INTERACTIVE AND INTELLIGENT CYBER-SECURITY

(71) Applicant: Demisto Inc., Cupertino, CA (US)

(72) Inventors: Rishi Bhargava, Cupertino, CA (US); Slavik Markovich, Los Altos, CA (US); Meir Wahnon, Tel Aviv (IL)

(21) Appl. No.: 16/110,565

(22) Filed: Aug. 23, 2018

(51) Int. Cl. H04L 29/06; G06F 3/0481

(52) U.S. Cl. CPC H04L 63/20; G06F 3/0481; H04L 63/1425

(57) ABSTRACT

A comprehensive security operation platform with artificial intelligence capabilities which may collaborate and/or automate tasks. The platform comprises a processor and a computer-readable storage medium storing computer-readable instructions. The instructions, when executed by the processor, cause the processor to perform monitoring an input to a user interface associated with a cyber-security incident; based on the input, determining an action to recommend; and displaying a visualization of the action to recommend on the user interface. The action to recommend is determined based on past actions by users facing one or more past incidents similar to an incident associated with the user interface.

### FIELD

The present disclosure relates generally to systems and methods of implementing cyber security and more particularly to methods and systems of automatically combatting cyber security threats within one or more computer networks.

### BACKGROUND

As computer networks become commonplace in businesses, the threat of cyber-security attacks affecting users and devices throughout a network becomes ever more present. The need for an active cyber security threat monitoring system is critical. To combat the threat of cyber security attacks, organizations implement a large number of security products and hire many security analysts. As the threats of cyber security attacks grow in number and the increasingly large number of security products are installed on various user devices throughout a network, the ability of a security analyst to identify attacks in time to mitigate damage is hindered.

The large number of security products, instead of helping security analysts in combating security threats, complicate the issue by inundating security analysts with security alerts. Security analysts may investigate a number of different alerts daily, document each of them, and report them regularly. As a result, security analysts may end up having “alert fatigue” or otherwise become less responsive to each individual security alert. Much of the work security analysts perform is essentially duplicating past work of another security analyst.

A primary objective of cyber security systems, including work by cyber security analysts, is to ultimately maximize system security and minimize network damage resulting from cyber security threats. An ongoing challenge in cyber security analysis is combatting numerous threats playing out simultaneously across a network. Cyber security analysts must find ways to optimize the response time and maximize efficiency. Current products for cyber security threat analysis are simply lacking in efficiency and require many educated analysts working around the clock to identify, analyze, and remediate many types of threats across a network.

Contemporary security operation centers are typically understaffed with an exceedingly stressed workload. The lack of staff results in an increasing rate of error and low efficiency workflows. Meanwhile, the threat of cyber security incidents is ever-growing. As the number of cyber security incidents increases, the number of different cyber security analysis tools also increases.

Given the large variety of analysis tools and the wide-spectrum of cyber security incident types, The need to streamline the security analysis process is great. In some instances, a single cyber security analyst may use dozens of cyber security analysis tools. The large number of tools needed for the analysis inevitably results in a disjointed record-keeping process.

There remains a need for a more efficient system enabling cyber security analysts to be more efficient and capable of responding to threats requiring human interaction while being free from the distractions of tasks which are capable of being performed solely by a computer system. It is therefore desirable to provide an automated system of cyber security threat analysis.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment in accordance with at least some embodiments of the present disclosure;

FIG. 2 illustrates a network environment in accordance with at least some embodiments of the present disclosure;

FIG. 3A is a block diagram of a packet in accordance with at least some embodiments of the present disclosure;

FIG. 3B illustrates a database in accordance with at least some embodiments of the present disclosure;

FIG. 3C illustrates a database in accordance with at least some embodiments of the present disclosure;

FIG. 3D illustrates a database in accordance with at least some embodiments of the present disclosure;

FIG. 3E illustrates a database in accordance with at least some embodiments of the present disclosure;

FIG. 4 illustrates a user interface in accordance with at least some embodiments of the present disclosure;

FIG. 5A illustrates a user interface in accordance with at least some embodiments of the present disclosure;

FIG. 5B illustrates a user interface in accordance with at least some embodiments of the present disclosure;

FIG. 5C illustrates a user interface in accordance with at least some embodiments of the present disclosure;

FIG. 5D illustrates a user interface in accordance with at least some embodiments of the present disclosure;

FIG. 5E illustrates a user interface in accordance with at least some embodiments of the present disclosure;

FIG. 5F illustrates a user interface in accordance with at least some embodiments of the present disclosure;

FIG. 6A illustrates a user interface in accordance with at least some embodiments of the present disclosure;

FIG. 6B illustrates a user interface in accordance with at least some embodiments of the present disclosure;

FIG. 6C illustrates a user interface in accordance with at least some embodiments of the present disclosure;

FIG. 6D illustrates a user interface in accordance with at least some embodiments of the present disclosure;

FIG. 7 illustrates a user interface in accordance with at least some embodiments of the present disclosure;

FIG. 8 illustrates a user interface in accordance with at least some embodiments of the present disclosure;

FIG. 9 illustrates a user interface in accordance with at least some embodiments of the present disclosure;

FIG. 10 illustrates a user interface in accordance with at least some embodiments of the present disclosure;

FIG. 11 illustrates a user interface in accordance with at least some embodiments of the present disclosure;

FIG. 12 illustrates a user interface in accordance with at least some embodiments of the present disclosure;

FIG. 13 illustrates a user interface in accordance with at least some embodiments of the present disclosure;

FIG. 14 illustrates a user interface in accordance with at least some embodiments of the present disclosure;

FIG. 15 illustrates a user interface in accordance with at least some embodiments of the present disclosure;

FIG. 16 illustrates a user interface in accordance with at least some embodiments of the present disclosure;

FIG. 17 illustrates a user interface in accordance with at least some embodiments of the present disclosure;

FIG. 18 illustrates a user interface in accordance with at least some embodiments of the present disclosure;

FIG. 19 illustrates a user interface in accordance with at least some embodiments of the present disclosure;

FIG. 20 illustrates a user interface in accordance with at least some embodiments of the present disclosure;

FIG. 21 illustrates a user interface in accordance with at least some embodiments of the present disclosure;

FIG. 22 illustrates a user interface in accordance with at least some embodiments of the present disclosure;

FIG. 23 illustrates a user interface in accordance with at least some embodiments of the present disclosure;

FIG. 24 illustrates a user interface in accordance with at least some embodiments of the present disclosure;

FIG. 25 illustrates a user interface in accordance with at least some embodiments of the present disclosure;

FIG. 26 illustrates a user interface in accordance with at least some embodiments of the present disclosure; and

FIG. 27 illustrates a user interface in accordance with at least some embodiments of the present disclosure.

### DETAILED DESCRIPTION

What is needed is a comprehensive security operation platform with artificial intelligence capabilities which may collaborate and/or automate tasks, including complex and/or redundant security tasks. An automated system may assist security analysts and security operations center managers in discovering security incidents. A comprehensive security operations platform may combine intelligent automation scale and collaborative human social learning, wisdom and experience. An automated system may empower security analysts to resolve incidents faster and reduce redundancy through collaboration with peers in virtual war rooms. An automated system may automate security analyst work by executing tasks from the war room or by following playbooks defined by the security analysts.

A solution to the disconnect between human-interaction and documentation of cyber-security issues is described herein. By integrating security analyst discussions, cyber-security applications, AI analysis systems, and IR workflows into a single application, the individual elements may reinforce each other and improve the overall efficiency of the analysis of a cyber-security event. What is needed is a single application to interweave knowledge and actions of software engineers, development servers, code scripts, and chatbots.

For example, when a cyber-security incident occurs, a security analyst may use one window on his or her personal computer to run investigation commands, another window to converse with fellow analysts, and a third window to document IR processes and logs. Using a system as described herein, a security analyst may use a single window to run investigation commands, converse with fellow analysts, and to document the process. The system as described may also implement powers of chatbots and other security tools to enhance overall efficiency of the analysis process.

The system disclosed herein allows for multiple analysts to collaborate within a single window. The window may allow for every chat, action, and command entered by each analyst to be tracked and viewed by all other analysts. This allows for increased transparency in the security incident analysis process. Accountability may be tracked and ownership of tasks may be linked to specific analysts. Successful series of tasks may be identified and made to be repeatable.

Analyzing and resolving a cyber-security incident often requires multiple security analysts working in tandem. In some instances, a first security analyst may begin working to resolve a cyber-security incident and may hand the incident off to one or more other security analysts to continue working to resolve the incident. Because a single incident may be handled by multiple security analysts, sharing information gained by each analyst with the other analysts working on the incident is critical to improving the efficiency of the incident resolution process.

Sharing information with other analysts working on the same incident is critically important. Also important is recording information gained from the analysis of one incident to be used in the analysis of future incidents. Recording such information to be shared is rarely a primary concern for analysts working on resolving an incident. Resolving cyber security incidents is often a time-critical process. Taking the time to record the steps performed, verifying the success of such steps, and sharing valuable information gleaned during the course of an incident resolution would improve the overall efficiency of the incident resolution process, but is not a realistic goal for overworked security analysts working on a large number of incidents at the same time.

These and other needs are addressed by the various embodiments and configurations of the present invention. The invention is directed generally to automated and partially-automated methods of analyzing security threats as well as methods and systems for assisting human security analysts in the identification and targeting of security threats. By utilizing a system of automating, either fully or partially, steps required during a security threat analysis, security analysts may be free to pursue other tasks, for example tasks requiring human input. These and other advantages will be apparent from the disclosure of the invention(s) contained herein.

The phrases “plurality”, “at least one”, “one or more”, and “and/or” are open-ended expressions that are both conjunctive and disjunctive in operation. For example, each of the expressions “a plurality of A, B, and C”, “at least one of A, B, and C”, “at least one of A, B, or C”, “one or more of A, B, and C”, “one or more of A, B, or C”, and “A, B, and/or C” means A alone, B alone, C alone, A and B together, A and C together, B and C together, or A, B and C together.

The term “a” or “an” entity refers to one or more of that entity. As such, the terms “a” (or “an”), “one or more”, and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The term “data stream” refers to the flow of data from one or more, typically external, upstream sources to one or more downstream reports.

The term “dependency” or “dependent” refers to direct and indirect relationships between items. For example, item A depends on item B if one or more of the following is true: (i) A is defined in terms of B (B is a term in the expression for A); (ii) A is selected by B (B is a foreign key that chooses which A); and (iii) A is filtered by B (B is a term in a filter expression for A). The dependency is “indirect” if (i) is not true; i.e. indirect dependencies are based solely on selection (ii) and or filtering (iii).

The terms “determine”, “calculate” and “compute,” and variations thereof, as used herein, are used interchangeably and include any type of methodology, process, mathematical operation or technique.

The term “item” refers to data fields, such as those defined in reports, reporting model, views, or tables in the database.

The term “module” as used herein refers to any known or later developed hardware, software, firmware, artificial intelligence, fuzzy logic, or combination of hardware and software that is capable of performing the functionality associated with that element. Also, while the invention is described in terms of illustrative embodiments, it should be appreciated that individual aspects of the invention can be separately claimed.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

Although the present disclosure is discussed with reference to security analysis systems, it is to be understood that the invention can be applied to numerous other architectures, such as any system utilizing a computer network and/or a network of less sophisticated computing devices like the Internet of Things (IoT). The present disclosure is intended to include these other architectures and network types.

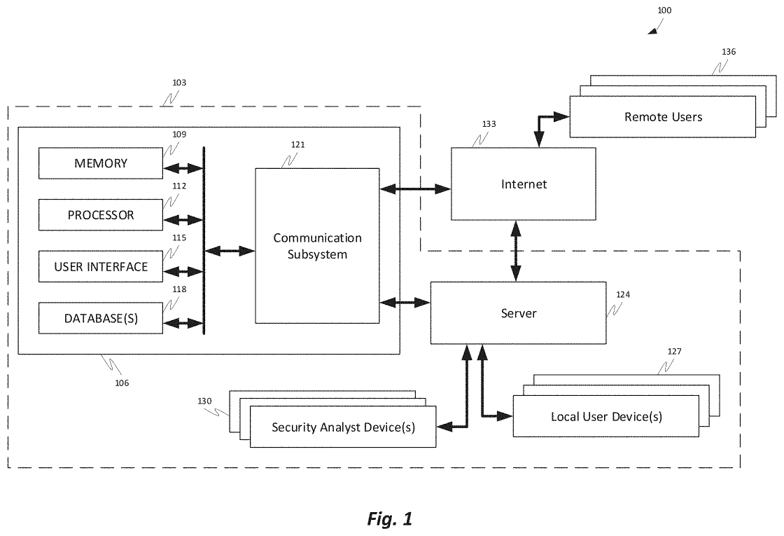

As illustrated in FIG. 1, a computer network environment 100 in accordance with some embodiments may comprise a local network 103 in communication with a wide area network (WAN) such as the Internet 133. In some embodiments, a local network 103 may comprise a security operation platform 106. A security operation platform 106 may be a computer system comprising one or more memory devices 109, one or more processors 112, one or more user interface devices 115, one or more databases 118, and a communication subsystem 121. The security operation platform 106 may, in some embodiments, be part of a local network 103 comprising a local server 124 and a number of local user devices 127. The local network 103 may further comprise one or more security analyst devices 130 in communication with the security operation platform 106 via the server 124. The communication subsystem 121 of the security operation platform 106 may be connected to and in communication with the local server 124 as well as a wide area network (WAN) such as the Internet 133. Via the Internet 133, the security operation platform 106 may be capable of communicating with a number of remote users 136, which may or may not correspond to trusted or known users. Although not depicted, the local network 103 may be separated from any untrusted network (in the form of the Internet 133) by a firewall, gateway, session border controller or similar type of network border element. In some embodiments, a firewall and/or gateway may be positioned between the server 124 and Internet 133. The same firewall and/or gateway or a different firewall and/or gateway may be positioned between the communication subsystem 121 and the Internet 133. The placement of the firewall and/or gateway enables the firewall and/or gateway to intercept incoming and outgoing traffic travelling between the Internet 133 and local network 103. As is known in the networking arts, the firewall and/or gateway may perform one or more inspection processes on the data packets/messages/data streams passing there through and, in some instances, may intercept and quarantine such data packets/messages/data streams if determined to be (or likely to be) malicious.

The security operation platform 106 may also be in communication with one or more security analyst devices 130. For example, a security analyst working at a security analyst terminal, computer, or other computing device 130, may be capable of working in tandem with the security operation platform 106. Data may be shared between the security operation platform 106 and the one or more security analyst devices 130.

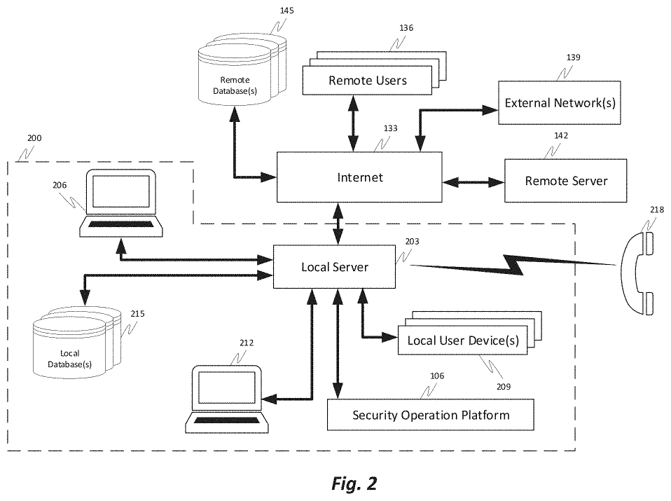

As illustrated in FIG. 2, the Internet 133 may provide access to one or more external networks 139, external servers 142, remote user devices 136, remote databases 145, and web services.

The local network 200, in some embodiments, may comprise one or more local servers 203, network administrator devices 206, local user devices 212, local databases 215, etc. As with FIG. 1, although not depicted, a firewall and/or gateway device may be positioned between the local server 203 and Internet 133, thereby providing security mechanisms for the network 200.

The security operation platform 106 may also be capable of placing telephone calls via a phone line 218 or via VoIP and/or sending automated email messages.

Telephone calls made by the security operation platform 106 may be automatically dialed by the system and conducted by a security analyst user of the security operation platform 106. In some embodiments, the security operation platform 106 may present a notification display to the security analyst user instructing the security analyst user with details on which number to dial and what questions to ask. In some embodiments, the security operation platform 106 may auto-dial the number and instruct the security analyst user to ask particular questions. In some embodiments, the security operation platform 106 may auto-dial the number and play recorded messages instructing a receiver of the phone call to input data via the telephone.

Similarly, emails may be automatically drafted and sent by the security operation platform 106 in some embodiments, while in other embodiments the security operation platform 106 may instruct a security analyst to draft and/or send the email.

The security operation platform 106 may be capable of automatically making a number of machine-to-machine inquiries. For example, if the security operation platform 106 determines certain data is required, the security operation platform 106 may determine a location, e.g. a network location, where such data may be found. The security operation platform 106 may then send a request or poll or otherwise gather such data.

In some embodiments, a workflow may begin upon a cyber security event being detected or upon a user request. For example, a user may submit information to a security operation platform providing details on a suspected cyber security threat. Alternatively, a security operation platform may detect a cyber security event occurring on a network.

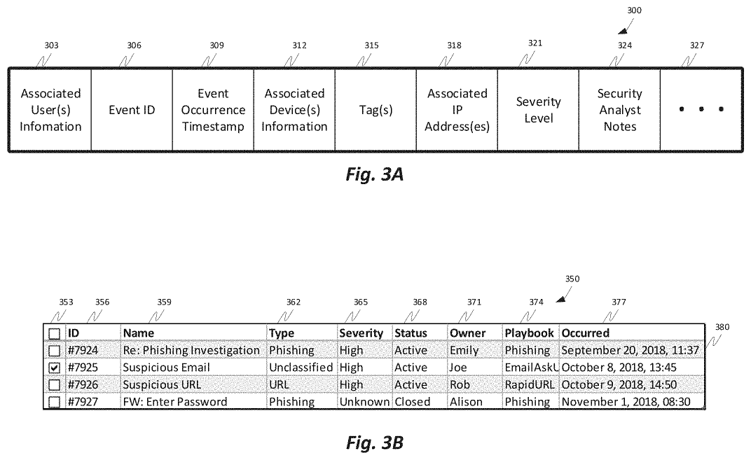

All known information associated with a particular cyber security event may be collected. Such information may be used to generate an incident identifier. An incident identifier may comprise a data packet, csv file, etc. and may be used as a database of all known information associated with the particular cyber security event. A data packet 300 which may be an incident identifier as discussed herein is illustrated in FIG. 3A.

A data packet, or incident identifier, 300 may comprise data such as associated user information 303 for users associated with the incident. For example, the user requesting the cyber security analysis may automatically be added as an associated user. Information identifying the requesting user may be a user ID, an email address, a device IP address, a phone number, etc. Other data associated with an associated user may be saved within the incident identifier, or may be saved in a database accessible to a cyber security analyst. For example, an associated user information filed may be a user ID which may be used by a cyber security analyst (or by a security operation platform) to look up additional user information, such as a phone number, email address, list of associated devices, etc.

An incident identifier 300 may also comprise data used to identify the event 306. For example, upon a request for event analysis or upon detecting a cyber security threat event, a security operation platform may assign an event ID 306. An event ID 306 may be used to look up past events by reference.

An incident identifier 300 may also comprise data associated with an event occurrence timestamp 309. For example, a user requesting analysis of a potential cyber security threat may provide a time and date or an estimated time and date of an occurrence related to the potential cyber security threat. In some embodiments, a security operation platform may detect a potential cyber security threat and log the time of detection as an event occurrence timestamp 309.

An incident identifier 300 may also comprise data associated with associated device information 312. For example, if the analysis is being executed due to a request by a user, the user may provide information identifying the device or devices affected by the suspected threat. As more affected devices are discovered during analysis, the number of entries in the associated device information 312 field may grow. In some instances, the associated device information 312 field may be empty at the beginning of an analysis if no affected device is known.

An incident identifier 300 may also comprise data associated with one or more tags 315. For example, an incident identifier 315 may be tagged with indicators such as “suspicious IP”, “suspicious URL”, “phishing”, “DDoS”, etc. Tags 315 may be added automatically by a security operation platform, or may be added manually by a security analyst. Tags 315 may be used to search through a number of incident identifiers 300 and may be used to find similar incidents. For example, an illustrative user interface display window 350 is illustrated in FIG. 3B.

An incident identifier 300 may also comprise data associated with associated IP addresses 318. For example, each of the known affected devices may be associated with an IP address. Such IP addresses may be listed in the associated IP address 318 field. Other IP addresses may also be listed. Each IP address may also be tagged with additional information, such as “affected device”, “first affected device”, etc. The IP addresses may belong to any network device (or group of network devices) belonging to the local network.

An incident identifier 300 may also comprise data associated with a severity level 321. For example, if the analysis is being executed due to a request by a user, the user may provide information related to an estimated level of severity. The level may be a rating, for example on a scale of one-to-ten. In some embodiments, the severity level may be set automatically by a security operation platform.

An incident identifier 300 may also comprise data associated with security analyst notes 324. For example, if the analysis is being executed due to a request by a user, the user may provide textual information describing the background and circumstances of the security threat. In some embodiments, a security analyst may provide additional notes during analysis. In some embodiments, a security operation platform may automatically add notes based on analysis. In some embodiments, an incident identifier 300 may comprise other data 327.

As illustrated in FIG. 3B, information associated with a number of security threats may be catalogued in a database 350. Each entry 380 may comprise a checkbox 353, an ID number 356, a name entry 359, a security threat type 362, a severity rating 365, a status 368, an owner 371, a playbook 374, and an occurrence timestamp 377. In some embodiments, a database entry may have a greater or lesser number of fields. A database may be stored on a network connected device and may be accessible by a number of security threat analysts. A database may be continuously updated as new threats are identified. Each entry may be updated as new information is discovered about a particular threat. For example, a security analyst may be enabled by the database to view similar threats based on type, severity, occurrence time, owner, etc.

As illustrated in FIG. 3C, a database 381 may comprise a list of incident data entries. An exemplary incident data entry 382 may comprise a number of data fields including, but not limited to, an incident identifier, timestamps relating to incident creation, detection, and completion, known client devices affected by the incident, known networks affected by the incident, contact information associated with the one or more users reporting the incident, a rating of severity of the incident, an owner of the incident, an identification of a device associated with the owner of the incident, one or more experts associated with one or more tasks associated with the incident, one or more playbooks associated with the incident, one or more other incidents associated with the incident, one or more details of the incident, any other fields as may be defined by a user or customer, etc.

With each incident, there may be one or more other incidents which relate to the incident in some way. For example, a number of incidents may be related by a category type, such as a suspicious email incident, or a suspicious file incident, etc. For each group of related incidents, data may be collected in a database 383 as illustrated in FIG. 3D. Such data may include, for example, an indication of which analyst was assigned as owner of each incident, and an indication of the outcome of the incident.

As illustrated in FIG. 3D, a database 383 may comprise a list of analysts and incident data associated with each analyst. An exemplary database 383 may comprise a number of entries with data fields including, but not limited to, an analyst identifier 384, a number of currently pending related incidents associated with each analyst, a number of completed incidents associated with each analyst, an average response time for each analyst based on related incidents, an adjusted rating for each analyst, etc.

As illustrated in FIG. 3E, a database 391 may comprise data for each analyst associated with each analyst's current workload. Such a database 391 may comprise data such as an analyst ID 392 for each analyst, a number of tasks due on the present day 393, a number of tasks due in the present week 394, a number of tasks due in the next 30 days or month 395, etc. In addition to, in the alternative of, a number of tasks, the database may comprise an estimated number of hours of estimated work for each timeframe. For example, some tasks may be estimated to be completed in a generally shorter amount of time compared with other tasks. In addition, some analysts may be more efficient at particular types of tasks. Such factors may be taken into consideration and may be used to complete the data fields in the database 391.

The databases illustrated in FIGS. 3D and 3E may be automatically created and updated with any changes by a security platform as illustrated in FIGS. 1 and 2. During operation of the system, the security platform may, upon detecting any update to the data, update the databases accordingly. Such updates may be performed by the security platform in real time, or periodically.

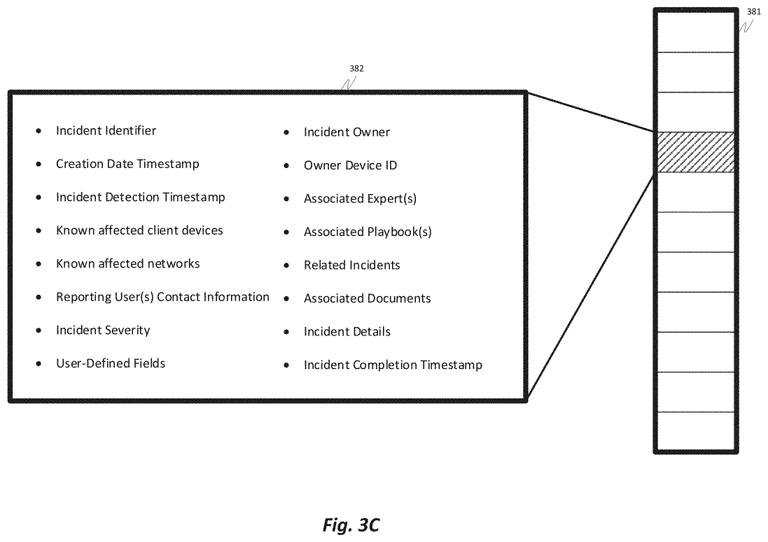

When a user becomes aware of a potential cyber security threat, the user may report the threat to a security operation platform via a form 400 as illustrated in FIG. 4. A form 400 may comprise a user interface displayed on a user device. In some embodiments, a form 400 may provide entry blanks for a user to fill out descriptions of a number of attributes associated with a potential cyber security threat. Information entered into a form 400 may be used to automatically create an entry in a database as illustrated in FIG. 3B.

In some embodiments, a form 400 may comprise entry forms for basic information about a potential cyber security threat such as name of the user, occurrence time and/or date of the threat, a reminder time and/or date, an owner, a type of threat, a severity level, a playbook, a label, a phase, and an entry form for details. In some embodiments, it may be typical for a user identifying a potential security threat to be unable to complete every entry in a form 400. For example, a user may receive a suspicious email. Such a user may decide to report the suspicious email. The user may open a security threat analysis application on the user's device and click a UI button opening a new incident form such as the form 400 illustrated in FIG. 4. Such a user may type the user's name in the form, the day and/or time the suspicious email was received, and may in a details box enter a short description, such as “suspicious email received”. In some embodiments, the form may allow a user to attach a file, such as a .msg file comprising the suspicious email, or an image file showing a screenshot or other relative information associated with the threat.

When details of a potential cyber security threat are received by a security operation platform, the security operation platform may begin a process of analysis of the potential threat. The process of analyzing the potential threat may begin by selecting a playbook from memory. One or more local databases accessible by a security operation platform may be capable of storing a number of playbooks in memory. A playbook may comprise a series of tasks. In some embodiments, a playbook may comprise a workflow for security analysts working with automated processes during a cyber security incident. A playbook may comprise a mix of both manual and automated processes or tasks.

A task in a playbook is typically any piece of an action that could be automated or scripted. Typically when an analyst is dealing with an incident, the analyst will want to go to some of the security products operating on a network server or a client device or elsewhere. They may want to go and simply query and collect information, or they may want to take an action. Each of these steps could be automated. For example, when we look at integrated products, there may be a number of security products integrated into the system. Tasks may be any number of security actions. For example, a task may be one or more of the following:
fetch <security product> search results
search <security product> for events
create new search job in <security product>
print all <security product> index names
update an existing event in <security product>
conduct a web search using <Google or Bing, etc.>
run a query of <security product> and receive results
generate random incidents per given parameter
search known actors based on given parameters
request/receive Intel Report
check [input file/IP/URL] reputation
input [IP address of a file] output: all known client devices containing the file
input [host name or IP] output: all devices associated with that input
input [request for computers running windows XP] output: list of computers running windows XP
input [domain name] output [domain reputation]
input [affected file] output [scanned file results]
add [input file] to blacklist [output: success]
input [name/IP of file] output [all known data, such as publisher, creator, owner, where is it found, is it bad or good, any known associated malware]
input [IP address], output [who registered to, who does it belong to, where is it geolocated, etc.]

A playbook may also comprise one or more conditional tasks in which a question is asked. For example, a first task may comprise a request for a reputation of a domain. A conditional task may ask a reputation question, e.g., if the reputation is bad, then perform task A and if the reputation is good, then perform the task B.

When an incident is created, playbooks may run automatically. When a manual task is initiated, the process along that chain may stop and wait for an input. An analyst may see a manual task, perform it, and input the requested output, or select a complete button.

One analyst may be assigned a number of different incidents. The analyst may not be aware of the automated tasks being performed. Manual tasks from each of the different incidents may appear as they begin on the analyst's terminal. The analyst may simply perform each one and click complete so that each playbook may continue.

One manual task may be answer yes or no and if the security analyst answers yes, the security platform may take one path and if the security analyst answers no, the security platform may take another path. Each playbook may be assigned to a particular analyst.

In some embodiments, the concept of a task may be broad. A task could as simple a step as sending an email, asking a question to another product, calling an API, wiping a system, anything which could be returned by a computer program could be an individual task. In the context of a security program, typically a task is more related to the API actions available in one or more security products. Actions supported by partnered security products via their API.

In some embodiments, a task may comprise the security platform automatically instructing an entity to perform a response action. Response actions may comprise one or more of reimaging an affected device and restoring the affected device from a backup. A response action may, in some embodiments comprise an identity of one or more processes with open connections executing on the affected device.

An input of a task does not need to be the output of the most immediately preceding task. An input of a task could be one or more outputs of one or more of any of preceding tasks. One task may comprise gathering information and such information may not be used in another task until three or more intermediate tasks have executed. As playbooks become more complex, for example a playbook comprising fifty or more tasks, if all outputs of all tasks are displayed to a user creating a new task as possible inputs, the design of the system may become overly complicated. Instead, the number of inputs visible to a user adding a task may be limited to only those outputs of preceding tasks within the new task's chain. So an analyst creating or editing a playbook may be assisted by the security platform pre-calculating possible tasks and flows for the playbook. Real-time calculations of the path may be made as the playbook is edited. Pre-filtering the list of options available for the user to choose based on real-time path calculation in the playbook may enable a more efficient workflow to be created.

A process, or task, may comprise the security operation platform requesting specific data from a network source. In some embodiments, certain tasks may be automated. For example, when a task is repeated and/or does not require human intervention, the security operation platform may automatically perform the task and retrieve data to update an incident identifier. Using retrieved data, the security operation platform may continue to perform additional tasks based on one or more playbooks. Automated tasks may comprise checking a reputation of an entity, querying an endpoint product, searching for information in one or more network locations, sending emails requesting data from users, making telephone or VoIP phone calls requesting data, and other potentially automated processes.

In some embodiments, certain tasks may be completable only by a human user. For example, if a task requires speaking with a user or otherwise collecting data not accessible via a network, the security operation platform may instruct a human security analyst to perform a task. While waiting for input from the security analyst, the security operation platform may either proceed to perform other tasks or may simply pause the process until input is received.

Each process may result in a modification to the following processes. For example, an output of a first process may be an input to a second process. The workflow of a playbook may follow a particular path based on an output of a task, for example the workflow may depend on a number of if-this-then-that statements.

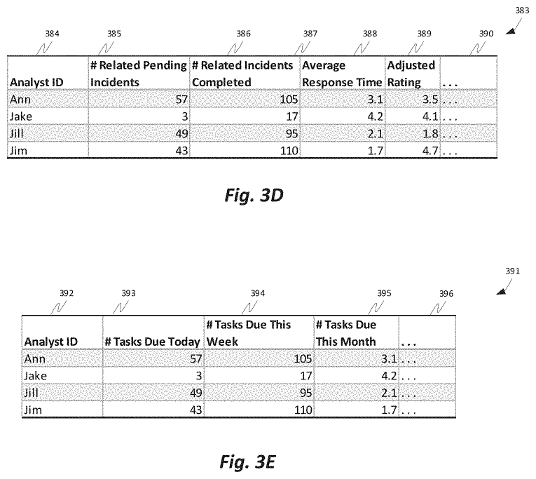

As illustrated in FIG. 5A, a playbook may be represented by a user interface visualization 500 presented on a user interface of a security analyst terminal. Note that the tasks listed in the playbook illustrated in the figures are example tasks only. Each playbook or task may begin with the playbook or task being triggered. When a user request for analysis of a potential security threat is received, or when a potential security threat is detected by a security operation platform, a playbook may be triggered. In the case of a task, the task may be triggered when all tasks preceding the immediate task have been completed.

In general, all tasks have inputs and generate outputs. Many playbooks may also accept or expect inputs.

When a playbook is triggered, a window on a security analyst terminal may present a flowchart or other representation of the tasks to be executed. As discussed herein, one playbook may comprise a number of playbooks and/or tasks. One such playbook comprising a number of tasks is represented by the rectangular dotted line 503 in FIG. 5A. Each entry in a playbook may represent a task. Each task may be automated or may require human interaction. A security analyst viewing the visualization of the playbook may be shown a symbol 506 indicating whether a task is automated. If a non-automated task is executed, a window 509 may be displayed within the visualization 500 to an analyst allowing for input.

In the example of FIG. 5A, the playbook 500 may be triggered which may cause an initial playbook to execute. The initial playbook may comprise a number of tasks, for example gathering affected user info or affected client device info. The initial playbook may also comprise receiving a quarantined suspicious file. Such tasks may be automated, manual, or a mix of automated and manual tasks. Automated tasks may be performed by a processor of a computing device, or security platform. Automated tasks may be performed in the background of a security analyst terminal. Manual tasks may comprise displaying instructions on a user interface of a security analyst terminal to be performed by a security analyst.

A playbook may have an output. The output of the initial playbook may be a suspicious file. Tasks or playbooks may comprise gathering data, such as suspicious files, user information, etc., and storing such data in a network location accessible to the security platform. Such data may be used in future tasks as inputs.

In the example of FIG. 5A, when the initial playbook has completed, the suspicious file gathered in the initial playbook may be used as an input to the next step 504. The next step 504 may comprise a processor of the security platform calling an API of a security product to extract details of the suspicious file. While many details of the suspicious file may be extracted in the step 504, not all may be inputs to following tasks. Continuing the example of FIG. 5A, the following step 505 may be a conditional task in which it is determined whether a malicious indicator was found among the details of the suspicious file.

In some embodiments, a playbook 525 may comprise a flowchart of one or more tasks or other playbooks as illustrated in FIG. 5B. A playbook 525 may comprise a first task or playbook 528, labeled in FIG. 5B as ‘A’. Note that any of the tasks of a playbook may comprise a number of other tasks. In general, a task will expect a particular piece or set of data in order to operate and will, in general, output one or more data points.

In some embodiments, a first task 528 may comprise a determination that all required inputs for the playbook to execute are accessible to the computer system executing the playbook. As an example, one playbook may be designed to send an email to all users of a particular type of client device alerting those users to a potential security threat. Such a playbook may require one or more pieces of data in order to begin, such as information associated with all users on a computer system, or IP addresses of all client devices, etc. Alternatively, such a playbook may require only an identity of a computer network and an identity of a cyber security threat. Other needed data may be collected via one or more tasks within the playbook before the emails are sent.

Tasks can be any action which can be automated or scripted. For example, querying a data source on a network or taking another action such as automatically drafting an email to be edited and/or sent by a security analyst. A task may comprise automatically searching a web browser search utility such as Google for a particular word, or may comprise wiping an affected system.

In some embodiments, client devices connected to the computer system may be executing one or more security computer program products. A security system as discussed herein may be designed such that security products on client devices can be queried to collect data gathered by the security products. For example, the security system discussed herein may be capable of utilizing APIs of a number of different security products on computer network objects existing across a network to gather data needed for one or more tasks.

A playbook may comprise a chain of tasks, wherein each task may accept as input one or more data points gathered in one or more of the previous tasks in the chain. To illustrate, in FIG. 5B, a task ‘L’ 531 may be capable of using data output from one of tasks ‘A’ 528, ‘B’ 534, ‘E’ 537, and ‘I’ 540. A playbook may be designed such that a task may never require input gathered from a task which is not a preceding task. For example, in FIG. 5B, task ‘L’ 531 may be designed such that no data gathered outside the chain of tasks ‘A’ 528, ‘B’ 534, ‘E’ 537, and ‘I’ 540 is needed to execute the task 531.

As such, execution of a task may stall until all preceding tasks have been completed. In the case of automated tasks, the system may make a determination that the proper output of a task has been received before moving to a following task. In the case of manual tasks, the system again may determine that the proper output of a task has been received before moving to a following task, or the system may rely on a security analyst to report to the system that a task has been completed.

In some embodiments, a security analyst may be enabled to quickly edit a playbook by simply adding tasks to an existing playbook. For example, as illustrated in FIG. 5B, a security analyst may take an existing playbook—as illustrated by those tasks in solid lines—and add a new task—illustrated by the dotted line task 543. Such a security analyst may place the new task 543 below task ‘D’ 546, indicating that the new task 543 should execute only after task ‘D’ 546 completes. The security analyst may draw a line as illustrated in FIG. 5B down from the new task 543 to the input of task ‘M’ 549. By adding the new task 543 as an input to task ‘M’ 549 of the existing playbook, the security analyst may ensure that task ‘M’ 549 will not execute until the data collected in task 543 is output by the system. Note that task ‘M’ 549 may also not execute until all of tasks ‘A’ 528, ‘B’ 534, ‘C’ 552, ‘D’ 546, ‘E’ 537, ‘F’ 555, ‘G’ 558, ‘H’ 561, ‘I’ 564, and the new task 543 have output the expected data points. Similarly, task ‘O’ 567 may not execute until all of tasks ‘A’ 528, ‘B’ 534, ‘C’ 552, ‘D’ 546, ‘E’ 537, ‘F’ 555, ‘G’ 558, ‘H’ 561, ‘I’ 540, ‘J’ 564, ‘K’ 570, ‘L’ 531, ‘M’ 549, ‘N’ 573 and the new task 543 have output the expected data points. In some embodiments, there may be fail safe systems such that in the event a particular data point cannot be gathered, for whatever reason, the system may carryon in the absence of such a data point.

An example playbook 575 is illustrated in FIG. 5C. The playbook may be triggered 576 upon any number of events. For example, a task of another playbook may detect a particular potential security threat and, upon such a detection, the task may trigger the playbook of FIG. 5C. In some embodiments, a security analyst may determine the playbook of FIG. 5C is needed for the analysis of a particular cyber security threat. The playbook illustrated in FIG. 5C may be designed to generate and output a list of machines on a computer system having one or more of SHA1, MD5, and/or SHA256. The input to the system may comprise an identity of a computer system.

Upon the playbook being triggered 576, the example playbook 575 may execute three tasks in parallel as illustrated by tasks 577, 578, 579. In the example of FIG. 5C, the three parallel tasks may comprise a task 577 of finding all machines that have SHA1 on the input computer system, a task 578 of finding all machines that have MD5 on the input computer system, and a task 579 of finding all machines that have SHA256 on the input computer system.

The task 580 may not execute until either all three tasks 577, 578, 579 have executed to completion or fewer than all three if it is detected that one of the three previous tasks could not be executed. The tasks 577, 578, 579 may each be automated tasks, automatically finding the machines, or one or more of the tasks 577, 578, 579 may be a manual task. Each one of the three tasks 577, 578, 579 may output a list which may be used as an input to the task 580. Task 580 may also use as an input any input to the playbook 575 as well as any output of the first task 576. In the example of FIG. 5C, task 580 comprises taking the lists output from tasks 577, 578, 579 and creating a list of machines having one or more of SHA1, MD5, and/or SHA256 on the computer system and reducing the list such that there is no duplication. Following the completion of task 580, the playbook may comprise outputting the list 581.

As illustrated in FIG. 5D, one element 582 of a playbook 583 may comprise another playbook 584. As a playbook may have one or more inputs and provide one or more outputs, a playbook may be very complex or simple. A task of a playbook may comprise one or more automated tasks as well as one or more manual tasks, or a task may comprise one or more solely automated or manual tasks. In the example of FIG. 5D, the task 582 may comprise the playbook 584. By representing an entire playbook as one task, new and complex playbooks may be created by a security analyst quite quickly without requiring each sub-task to be planned.

As some tasks, and some entire playbooks, may be automated, the processing of automated tasks may run in the background of the security platform system. A security analyst assigned to a particular security threat may not have a need to spectate the playbook operation and may only see those tasks which require manual input. Moreover, one security analyst may be assigned a number of potential security threats or incidents.

Such a security analyst may have a security analyst terminal, or PC, with a user interface 585 as illustrated in FIG. 5E. As can be appreciated, a security analyst terminal user interface 585 may display one or more pending tasks assigned to the security analyst as well as one or more tasks completed by the security analyst. A security analyst at the security analyst terminal may be capable of selecting a pending task and the user interface 585 may display information about the selected task. Information about the selected task may comprise information such as a deadline timestamp for the security analyst to complete the task, a severity of the task, an assigned analyst ID, a task ID, an incident ID, a playbook ID, as well as instructions for completing the task and buttons to input the information needed by the task. The user interface 585 may also allow for a security analyst to input notes associated with completing the task which may be saved in a report associated with the incident.

The user interface 585 may also at times comprise a display informing a cyber security analyst that a recommendation that an assistant for a present task should be assigned has been made by the security platform. The user interface 585 may in such times allow a cyber security analyst to initiate such a recommendation process.

A security analyst may be capable, using a security platform, to create a task or playbook either from scratch or from other tasks or playbooks. For example, a security analyst may create a playbook from a number of existing tasks by dragging and dropping tasks into a playbook creator user interface as illustrated in FIG. 5F. Lines may be drawn by a security analyst into a task from another task indicating an order of operation. When a new line is drawn from the bottom of a task into the top of another task, the creating user may be shown a display of available inputs. For example, as illustrated in FIG. 5F, new task E has been added to the playbook. Line 590 may be drawn from task C into task E. A window 591 may pop up as the line 590 is drawn. As the line 590 is drawn out of C, all outputs of C as well as the outputs of A, being prior to tasks C and E, should be available as inputs to task E. The window 591 may allow a user to select from those outputs to decide on an input to the new task E. The window 591 may also allow for a user to select from one or more recommended inputs. Inputs may be recommended by the security operation platform based on a number of factors, such as popularity, past success rate, current situation, or other relevant factors.

The available inputs may comprise all outputs of all tasks or playbooks above the new lower task. In this way, it may be ensured that the playbook will never need a data point from a task that has yet to be executed. That is, by the time the new task has begun, all previous tasks will have executed and thus all requisite inputs for the task will have been gathered.

A security analyst may also be capable of selecting a number of tasks and saving them as a new playbook. Such a playbook, comprising any number of tasks, may be represented as a simple task, as illustrated in FIG. 5D. Such representation may enable security analysts to build increasingly complex playbooks without requiring every single task to be selected with each new playbook.

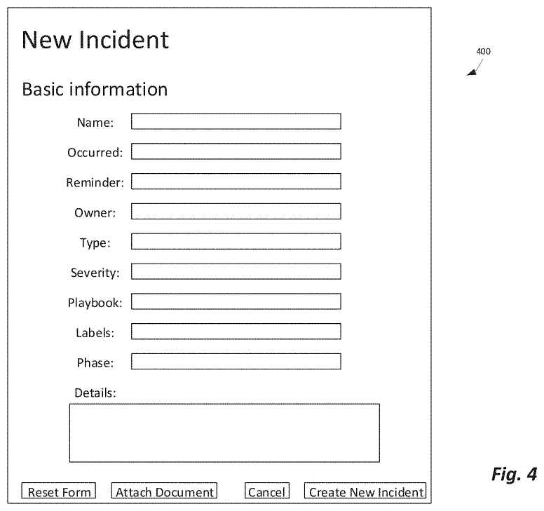

As illustrated in FIG. 6A, a user interface 585 may at times comprise a window 601 informing a cyber security analyst viewing the user interface 585 that a recommendation of reassigning a present task to an expert analyst has been made by the security operation platform. The window 601 may allow for input to be received from the cyber security analyst viewing the user interface 585. The cyber security analyst may be allowed to view one or more suggested expert analysts via the user interface 585.

As illustrated in FIG. 6B, a user interface 585 may at times comprise a window 602 informing a cyber security analyst viewing the user interface 585 that the cyber security analyst has been assigned as an owner of a new incident by the security operation platform. The window 602 may allow for input to be received from the cyber security analyst viewing the user interface 585. The cyber security analyst may be allowed to view details of the newly assigned incident via the user interface 585.

As illustrated in FIG. 6C, a user interface 585 may at times comprise a window 603 informing a cyber security analyst viewing the user interface 585 that the cyber security analyst has been assigned as an expert analyst of a task of an incident owned by another cyber security analyst by the security operation platform. The window 603 may allow for input to be received from the cyber security analyst viewing the user interface 585. The cyber security analyst may be allowed to view details related to the newly assigned task via the user interface 585.

As illustrated in FIG. 6D, a user interface 585 may at times comprise a window 604 allowing for a cyber security analyst viewing the user interface 585 to create a new task or add a new task to a playbook. The window 604 may have a text input box allowing for the cyber security analyst to type in a name for the new task. The window 604 may additionally display one or more suggested tasks based on the current playbook and/or current incident. The window 604 may further comprise one or more popularly chosen new tasks based on one or more tasks previously performed on the current incident based on tasks performed by one or more analysts working on similar tasks in the past. Such suggested and/or popular tasks may comprise verifying a URL, verifying an email address, checking a status, notifying one or more users, etc.

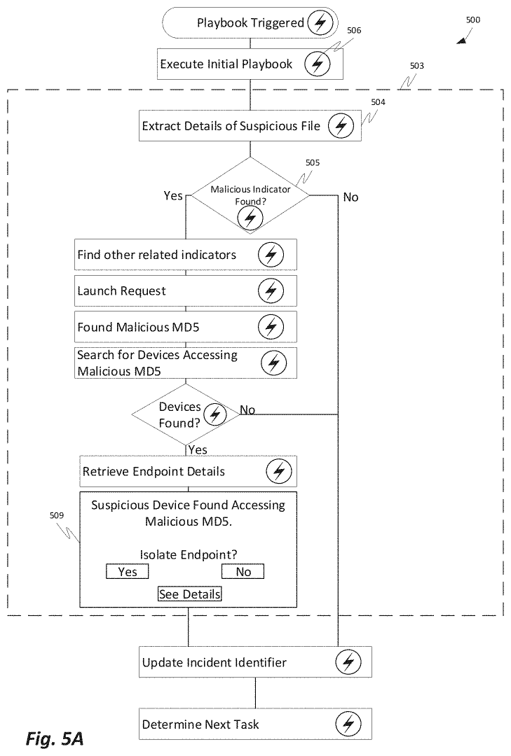

As illustrated in FIG. 7, a user interface 700 of a device used by a cyber security analyst may allow for a security analyst, upon learning of a new cyber-security incident, to create a new incident in a database associated with the cyber-security incident. For example, a security analyst may complete one or more fields which may be applied to the incident in the database as tags. Tags may comprise one or more of a name of the incident, an occurrence date and/or time, a reminder date and/or time, an owner of the incident, a type of incident, a severity of the incident, one or more playbooks to be assigned to the incident, one or more labels, one or more phases, details, and/or other fields containing data.

The name of the incident may be selected by a security analyst. The name may be related to the type of incident or may contain other identifying information. By way of example, the name of an incident may be “malware on a client device”, “lost laptop”, “attempting phishing attack”, etc.

The occurrence date and/or time may be chosen by a security analyst based on a known or estimated date and/or time of the occurrence of the cyber-security incident, a known or estimated date and/or time of an event related to the cyber-security incident, a date and/or time of the creation of the new incident in the database, or any other relative date and/or time.

A reminder date and/or time may be selected by a security analyst. In some embodiments, a security analyst may select a repeated reminder, for example a weekly, biweekly, monthly, etc. reminder may be set up. The reminder date and/or time, once selected by the security analyst may create a reminder event in a calendar of one or more security analysts associated with the incident.

The security analyst may also select an owner of the incident. The owner of the incident may be the security analyst completing the new incident UI form or may be a different security analyst. An owner of an incident may generally be responsible for completing the analysis of the cyber-security incident.

The type of incident field may be entered by a security analyst. The type may be selected from a group of incident types, such as phishing attempts, malware attacks, lost devices, etc. The type field may be used to sort incidents by type and to generate reports and complete various types of analysis.

The severity of the incident may also be selected by the security analyst from a group of severity types, such as “high”, “urgent”, “medium”, “low”, or other severity identifiers.

One or more playbooks may be assigned to the incident by the security analyst. Playbooks may be selected based on the type of incident or other qualities of the incident. In some embodiments, a playbook may be selected automatically based on one or more qualities of the incident.

One or more labels may be assigned to the incident by the security analyst. Labels may indicate particular qualities associated with the incident. Labels may be used in system analytics or may be used by security analysts to quickly generate and/or organize lists of similar incidents.

One or more phase identifiers may be selected by the security analyst. A phase identifier may be related to the response required for the particular incident. For example, an incident may be assigned a preparation phase, a response phase, or other type of phase.

Other details may be entered into a box 703 for example a security analyst may type a quick summary of the incident or information which does not neatly fit within one or more of the provided input fields.

In some embodiments, the user interface 700 may comprise other fields for other types of data to be entered by a security analyst.

The user interface 700 may further allow for a security analyst to attach one or more files to the incident using a UI button 706. For example, if the incident is related to a malware attack, a suspicious file may be attached to the new incident form, or if the incident is related to a phishing attack, an email related to the phishing attack may be attached.

Any of the above fields may be left blank in the creation of a new incident. As new data associated with a cyber-security incident is collected, the data entered into the new incident user interface 700 may be updated and/or otherwise changed.

A security analyst having completed one or more of the fields in the user interface 700 may select a “create new incident” button 709 and an entry in a database may be created to hold the information associated with the incident.

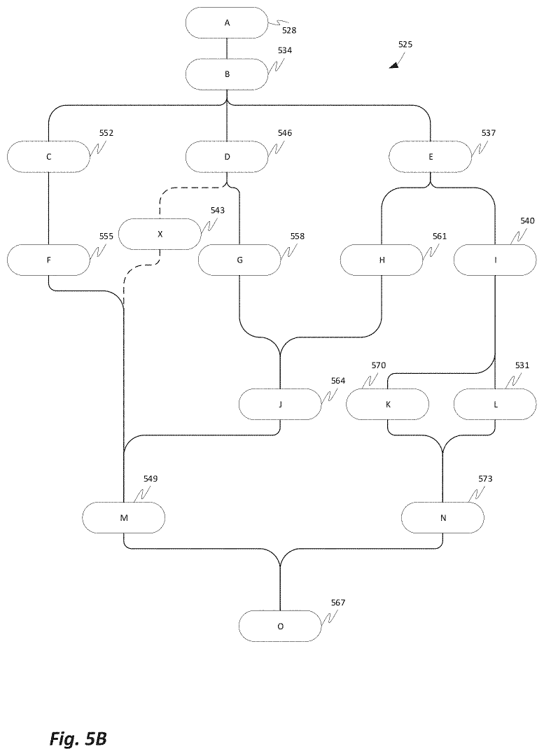

In some embodiments, an incident may be associated with an interactive user interface 800 as illustrated in FIG. 8. The interactive user interface 800 may be accessible by multiple users, or security analysts.

The interactive user interface 800 may comprise a text field 803 identifying an associated incident. The interactive user interface 800 may comprise a window 806 which may be used to display a number of entries 809 from one or more users and/or artificial intelligence bots. The interactive user interface 800 may be similar to an Internet relay chat application layer protocol. Each user interface 800 may be associated with a particular cyber security incident.

In some embodiments, an artificial intelligence bot may be an active participant in the user interface 800. In some embodiments, an artificial intelligence bot may be a passive listener or passive participant in the user interface 800. For example, the artificial intelligence bot may analyze any input into a user interface 800 by any user. The artificial intelligence bot may learn from any communication between users of the user interface 800.

As one or more analysts work through the process of resolving a cyber-security incident, any steps taken by an analyst may be recorded in the user interface 800. An artificial intelligence bot may passively listen, collect any information related to the steps taken by analysts, and learn from the inputs to the user interface 800. Any chat communication, uploaded file, command entered, or any other data input into the user interface 800 may be collected by the artificial intelligence bot. As discussed below, an artificial intelligence bot may be capable of interpreting particular inputs into the user interface 800 as commands and may actively respond by performing actions and/or responding visually with new entries into the user interface 800.

Using a user interface 800 as described herein in conjunction with an artificial intelligence bot, a highly-efficient way of saving records of cyber-security incident resolutions and of learning from past cyber-security incident resolutions may be established as described herein.

As illustrated in FIG. 8, a text field 812 may allow a security analyst accessing the interactive user interface 800 via a security analyst terminal to enter a new text entry. The text field 812 may allow a security analyst to input text messages, textual information, and/or commands to be displayed in the window 806. After typing a message or command the security analyst may click a send button 815 to deliver the message or command the window 806.

Files may also be uploaded by a security analyst by clicking an attach files button 818. For example, a security analyst working on resolving a cyber security incident may come across one or more files related to the incident. Such files may be uploaded to a database associated with the incident. Information relating to uploaded files may be displayed within the window 806.

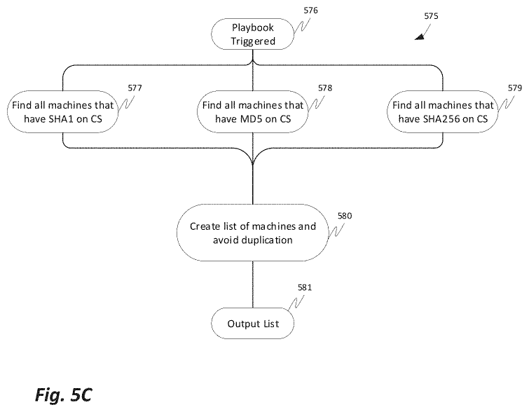

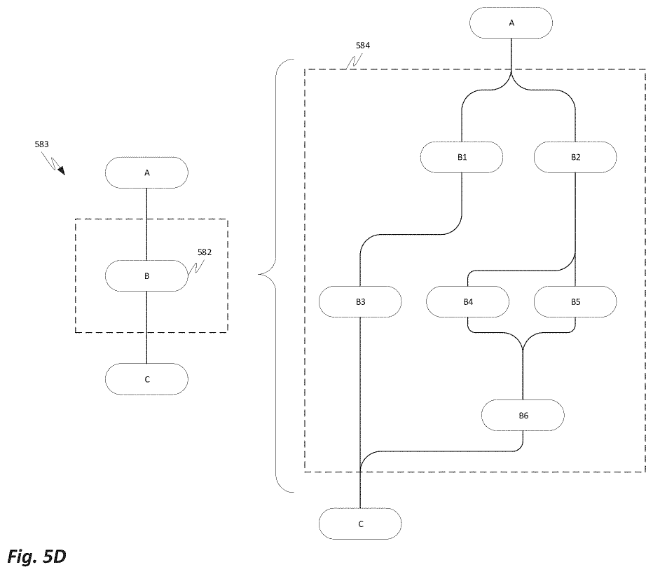

As a security analyst types into the text box 812, as illustrated in FIG. 9, suggestions may be presented in a window 900. To enter a command or script, a security analyst may introduce the command with an identifying character such as ‘!’. Upon entering an identifying character, the window 900 may present a list of possible commands. As the security analyst continues to type, as illustrated in FIG. 10, the window 900 may be updated to show possible commands matching the characters entered by the security analyst into the text box 812.

After entering a command in the text box 812 and hitting a send button 815, the command may be displayed in the window 806 to be viewable by any other security analysts working on the incident.

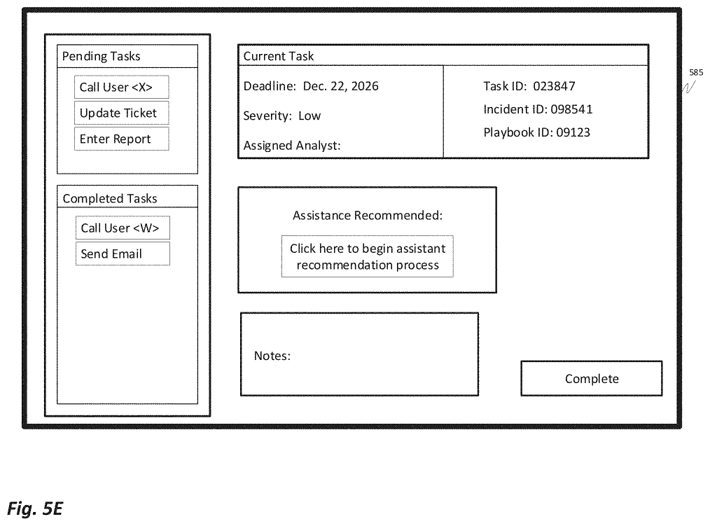

One such command may be to request a display 1100 of steps to be performed in accordance with a playbook related to the incident. As illustrated in FIG. 11, a playbook for a malware-type incident may comprise steps such as set initial incident context, retrieve device profile, retrieve employee information, review incident details, access severity, etc.

Security analysts viewing the user interface 800 may be capable of interacting with windows displayed. For example, steps of a playbook may be interacted with such that each may be marked as completed, assigned to a particular security analyst, assigned a due date, etc.

Each incident may be assigned to a particular security analyst. Such a security analyst may be considered an owner of the incident. Other security analysts may also be assigned to the incident. In some embodiments, a security analyst may be assigned to a particular task of an incident.

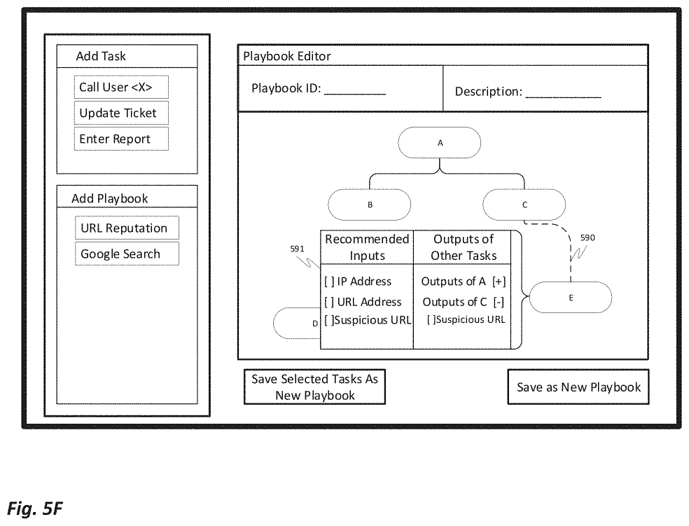

Security analysts viewing the user interface 800 may be capable of viewing a window 1200 displaying any current investigation members as illustrated in FIG. 12. Such a window 1200 may also allow a security analyst to add or remove security analysts to or from the incident.

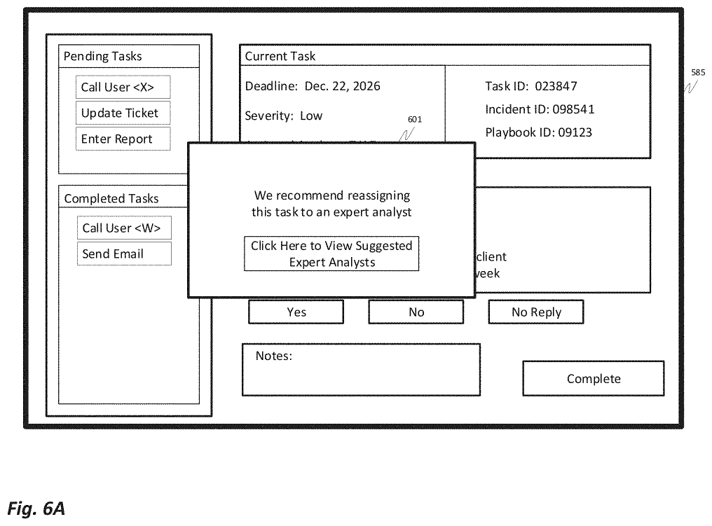

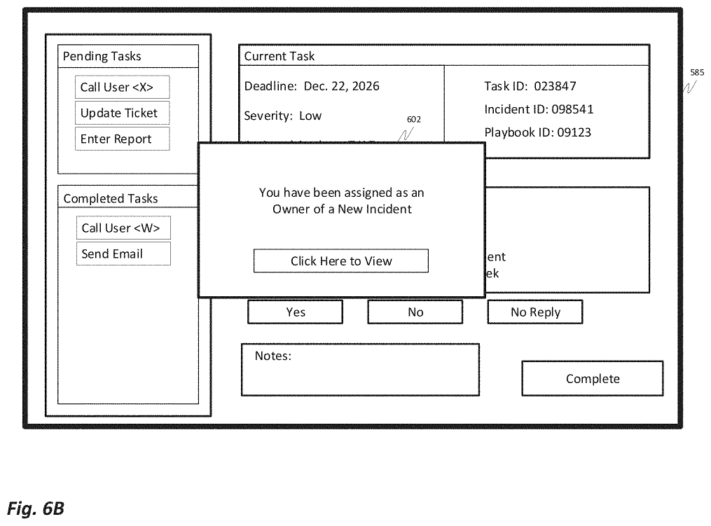

As illustrated in FIG. 13, the text box 812 of the user interface 800 may allow a user to send a direct message to another user. As illustrated in FIG. 14, a message 1400 typed into the text box 812 may be presented in the user interface 800 and may be viewable by other security analysts.

Messages typed into the text box 812 and sent to be displayed in the user interface 800 may be analyzed by an artificial intelligence system. Messages such as “@allen—can you help me” may be interpreted by the artificial intelligence system as a message to a user “allen”. Upon determining a message is directed to a particular user, the artificial intelligence system may add the particular user as a current investigation member. Any action performed by the artificial intelligence system for a particular incident may appear within the user interface 800 as a separate entry 1403 of the window 806.

An artificial intelligence system may actively monitor any input into a user interface 800. The artificial intelligence system may be capable of identifying data entered in the user interface 800 as evidence and use data identified as evidence to build an evidence file. Each incident may be associated with an evidence file. An evidence file may comprise a list of information and attached files relating to an investigation of a particular incident.

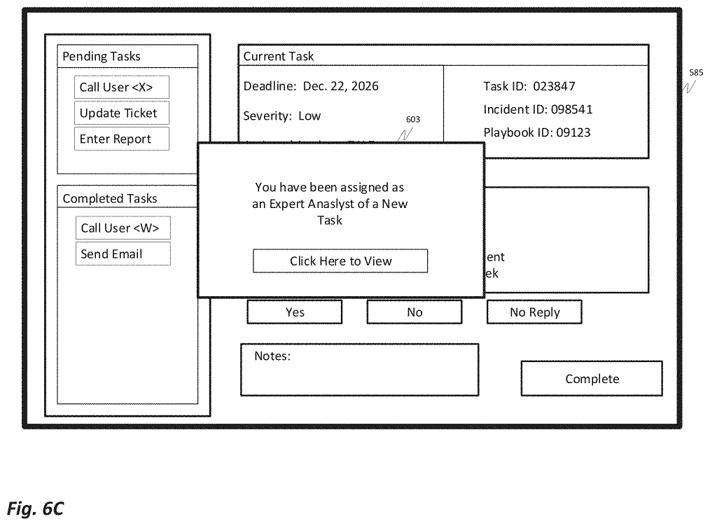

§An artificial intelligence system may further be capable of identifying other actionable items entered by a security analyst into the text box 812 and sent to the user interface 800. For example, as illustrated in FIG. 15, a security analyst may send a message 1500 to another analyst requesting a task to be performed or some piece of information to be gathered. Such a message 1500 may comprise information such as an IP address, a URL, or other identifiable information. An artificial intelligence system may be capable of identifying such identifiable information and performing an action. For example, if an artificial intelligence system detects an IP address within a message 1500, the artificial intelligence system may perform a data lookup on the IP address and allow users to view data relating to the IP address as gathered by the artificial intelligence system by adding a hyperlink 1503 to the message 1500.

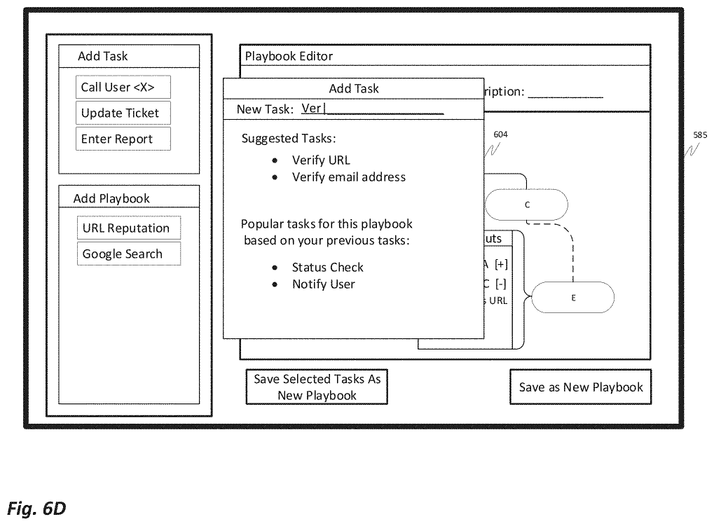

As illustrated in FIG. 16, the data relating to the IP address as gathered by the artificial intelligence system may comprise research on a reputation of the IP address. A user may hover a cursor 1600 over the hyperlink 1503 and the user interface 800 may display a window 1603 containing information gathered by the artificial intelligence system. Information gathered by the artificial intelligence system by way of example may comprise a summary of an IP address's reputation level, suggestions of one or more scripts for a security analyst to execute, a listing of one or more investigations related to the IP address or other identified information investigated by the artificial intelligence system, and/or other information relating to the identified information investigated by the artificial intelligence system.

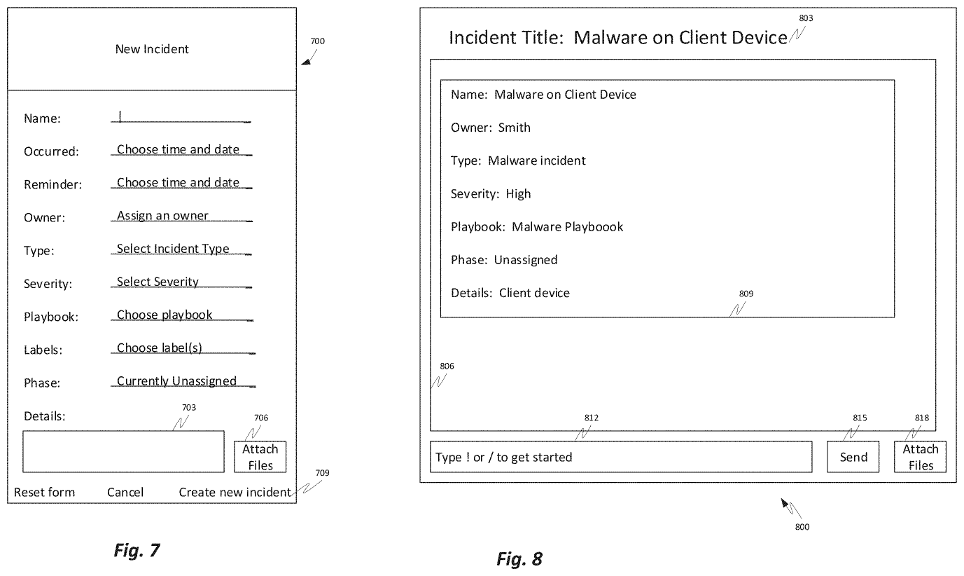

The user interface 800 may allow for a number of security analysts to communicate. For example, a message 1500 may be sent by a first security analyst from a first terminal and may be read by a second security analyst at a second terminal. The second security analyst may respond with a message 1700 as illustrated in FIG. 17. The messages 1500, 1700 may be analyzed by an artificial intelligence system.

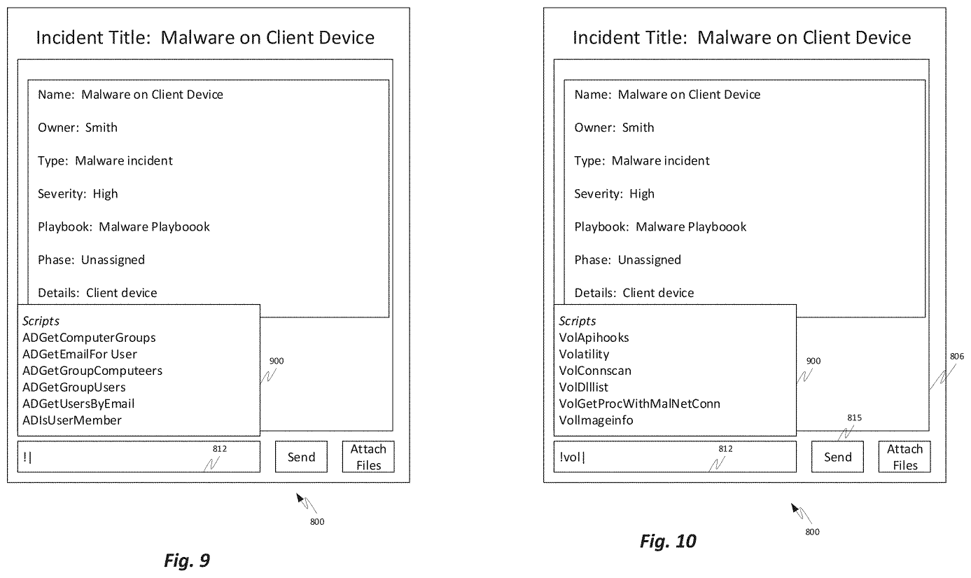

When a security analyst sends a message 1800 including a command as illustrated in FIG. 18, an artificial intelligence system may respond with a message 1803 showing the command has been received. The message 1803 from the artificial intelligence system may be displayed in the user interface 800 for any security analysts to view.

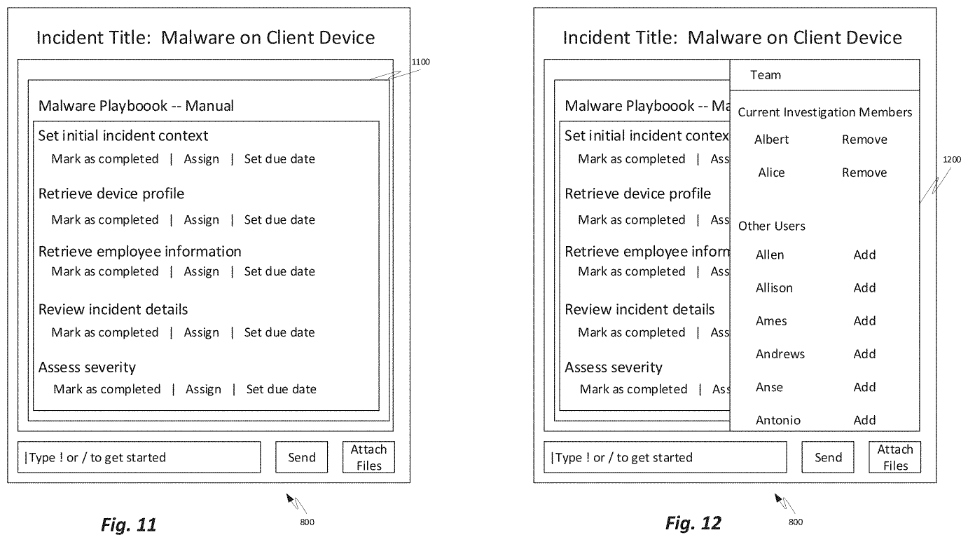

Commands entered into the user interface 800 may be interpreted and carried out by an artificial intelligence system. As illustrated in FIG. 19, after performing a commanded task, the artificial intelligence system may display results of the task in the user interface 800 in the form of a message 1900. This process of displaying commands, displaying responses, and displaying communications between members of an investigation team for a particular incident results in a fully-transparent system of analyzing security threats. This transparent system may be used by future analysts when confronted by a similar incident.

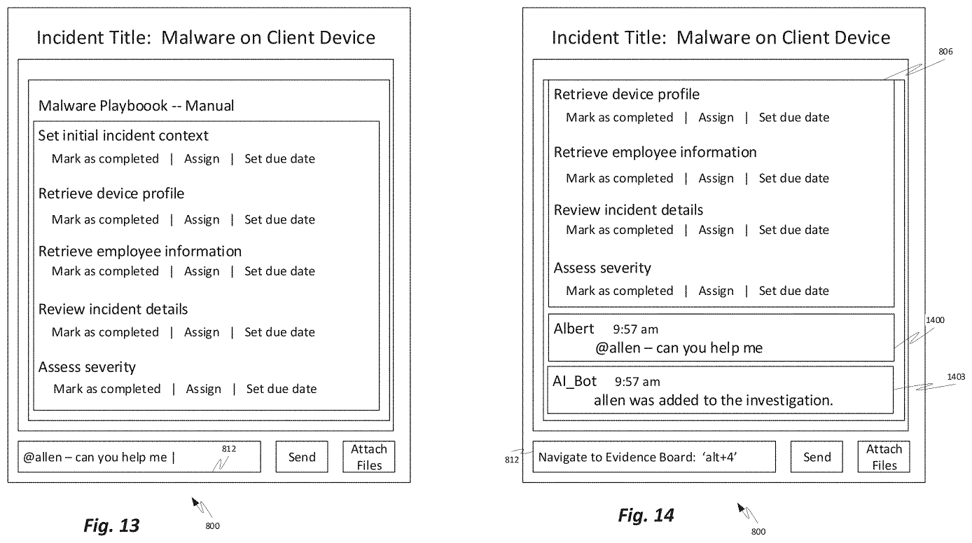

As illustrated in FIG. 20, an artificial intelligence system may carry out a number of tasks for a particular incident. As the artificial intelligence system progresses through the steps, the progress may be recorded in real time in the user interface 800. As the artificial intelligence system finishes a task, the artificial intelligence system may post a message 2000 stating that the task has been completed. After finishing a task, the artificial intelligence may determine if an additional task should be started. Determining whether an additional task should be started may comprise determining whether a playbook of tasks is associated with the incident. After determining a playbook of tasks is associated with the incident, the artificial intelligence system may determine a first task within the playbook which has not been completed. For example, after completing a task #14, the artificial intelligence system may post a message 2000 stating that the task has been completed. After finishing task #14, the artificial intelligence system may check that a playbook is associated with the incident. The artificial intelligence system may next determine a task #15 should be started.

After determining a task #15 should be started, the artificial intelligence system may post a message 2003 stating that the task #15 has been started. A message 2003 stating that a task has been started may comprise data such as a description of the task, a command to be executed in the performance of the task and a result of the execution of the command. For example, as illustrated in the message 2003 of FIG. 20, a task may comprise finding devices with a particular hash. The artificial intelligence system may determine a command ‘!Exists’ should be executed to complete the task. The artificial intelligence system may execute the !Exists task and display the result of the task in the user interface 800. After completing the task, the artificial intelligence system may post an additional message 2006 showing the task has been completed.

In some embodiments, an artificial intelligence system maybe capable of performing some or all tasks automatically. Tasks capable of being performed automatically may be described as automated tasks. In some embodiments, some tasks may require input from a source such as a security analyst. Tasks requiring input from a source may be described as manual tasks. After determining a new task to complete, the artificial intelligence system may next determine whether the task is an automated task or a manual task. If the task is an automated task, the artificial intelligence system may complete the task. If the task is determined to be a manual task, the artificial intelligence system may prompt a security analyst to respond to the task.

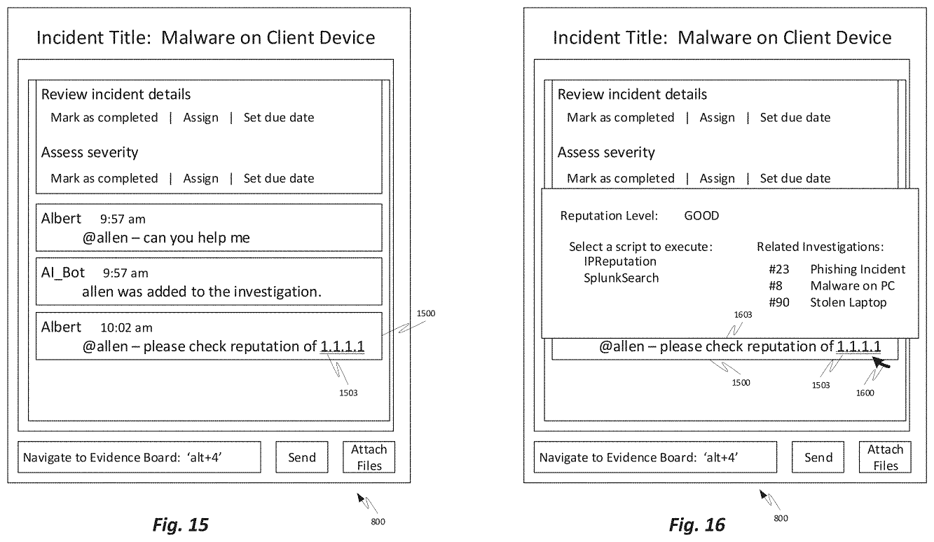

For example, as illustrated in FIG. 21, the artificial intelligence system may determine a task requires manual input from a security analyst. In such a case, the artificial intelligence system may prompt a security analyst by posting a message 2100 in the user interface 800.

In some embodiments, upon determining a task is a manual task, the artificial intelligence system may determine whether a particular security analyst should be responsible for the manual task. For example, the artificial intelligence system may determine whether a security analyst is an owner of the incident or whether a security analyst is currently assigned to the incident. If multiple security analysts are assigned to an incident and the artificial intelligence system determines no particular analyst is responsible for the task, the artificial intelligence system may post a message 2100 generally asking the question needing a response for the task.

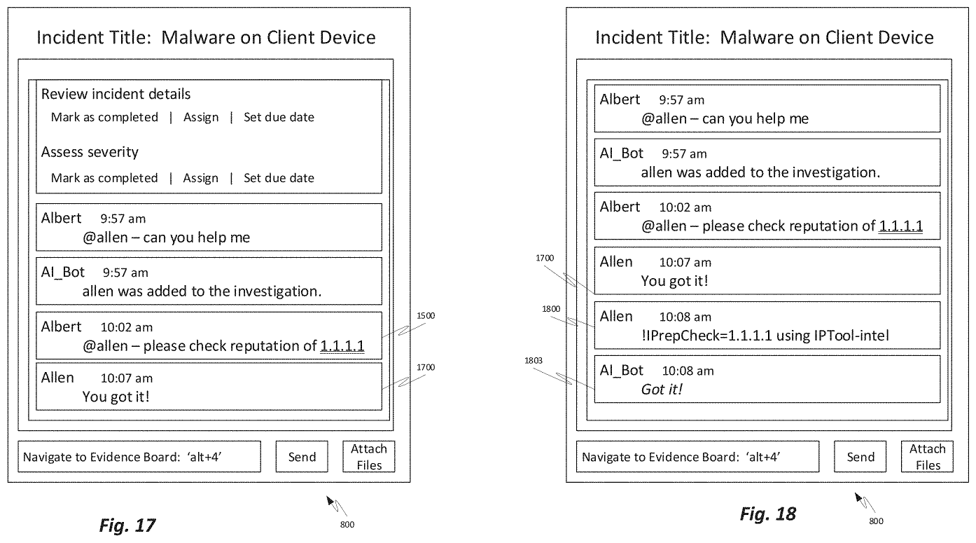

In response to the message 2100, as illustrated in FIG. 22, one or more security analysts may mention a security analyst in a message 2200. Mentioning a security analyst in a message may result in the artificial intelligence system adding the mentioned security analyst to the investigation team for the incident and post a message 2203 indicating the security analyst has been added. A user may also assign particular tasks to particular users by entering a message 2206 indicating such an assignment. The message 2206 may be displayed in the user interface 800.

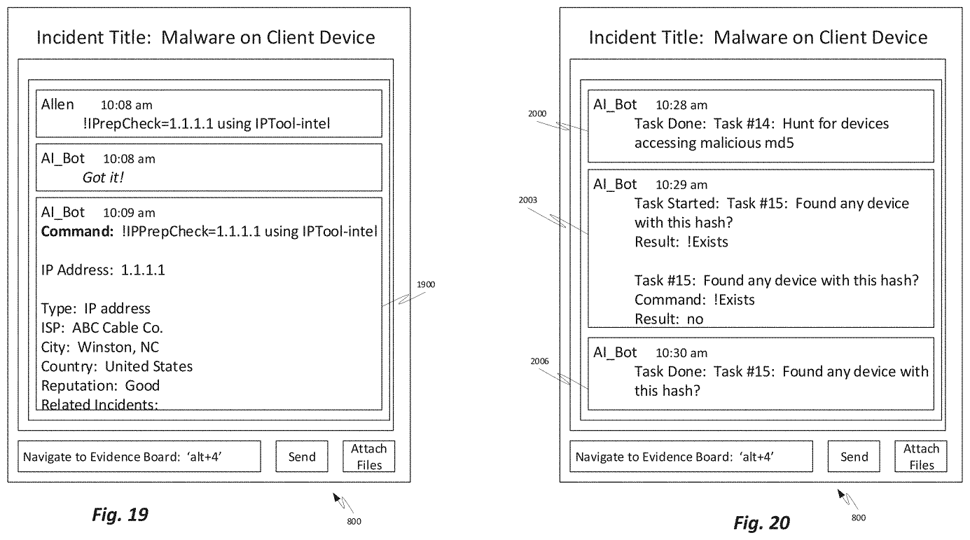

At any time during an investigation, a security analyst may select information presented in the user interface and mark such information as evidence. Selecting information and marking the information as evidence may result in a mark as evidence window 2300 being presented in the user interface 800 as illustrated in FIG. 23.

A mark as evidence window 2300 may comprise a number of fields which may be completed by a security analyst. For example, a security analyst may give a name to the evidence, provide a date and/or time relating to the evidence, write a written description, attach one or more files as linked evidence, show who or what was attacked, where the attack occurred, and/or any other relevant information. Information marked as evidence may be added to a database associated with the incident.

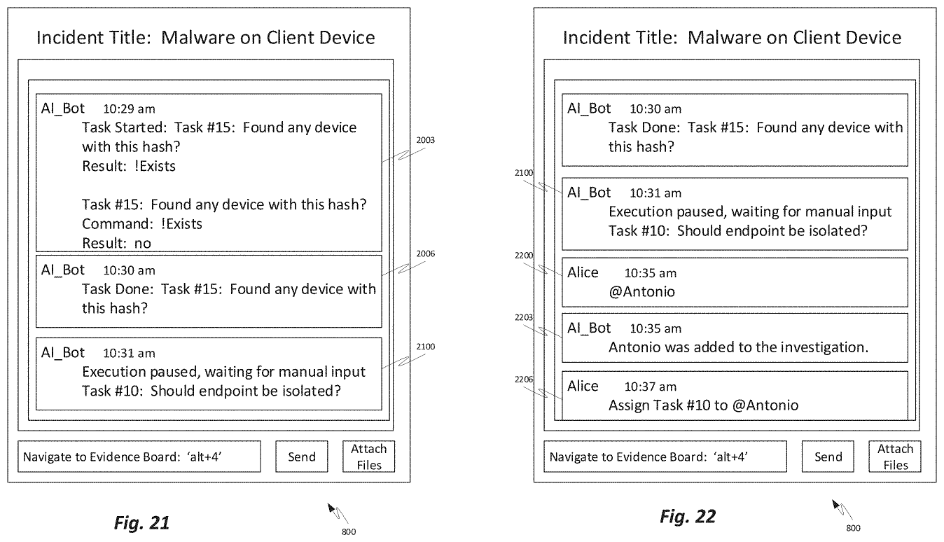

Security analysts may also be capable of using a terminal to view a dashboard user interface 2400 as illustrated in FIG. 24. A doashboard user interface 2400 may comprise data fields allowing security analysts to quickly overview statistics relating to incidents and incident resolutions. For example, a security analyst reviewing a dashboard user interface 2400 may be capable of viewing statistics such as a number of new incidents added to the system within a particular timeframe, a number of currently pending incidents, a number of new investigations begun within a particular timeframe, a number of currently overdue incidents requiring attention, details on any overdue or late incidents, an average amount of time to resolve an incident for a particular security analyst, an overview of current workloads of other security analysts, a number of currently active incidents by type, and/or any other relevant information relating to incidents which may be represented in a user interface 2400.

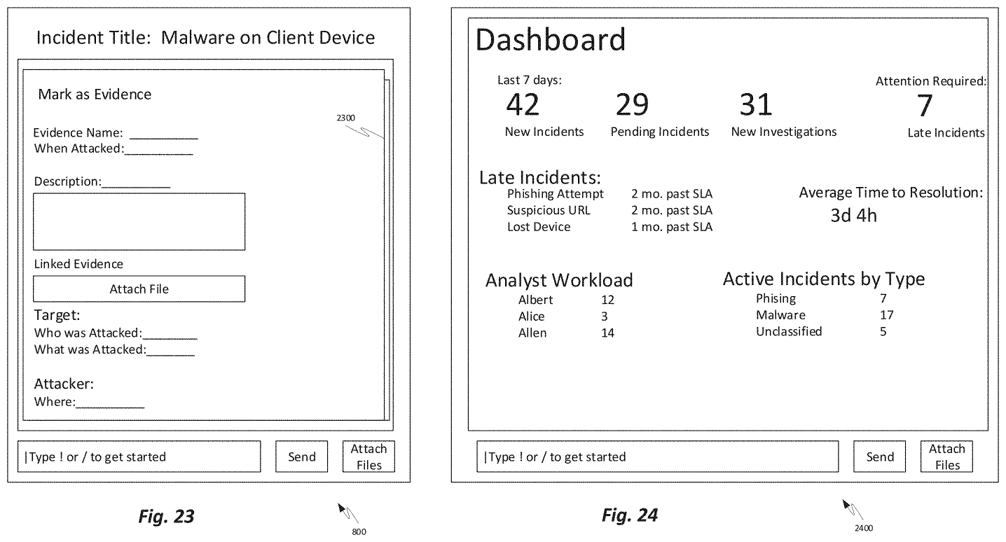

A security analyst terminal may also display a home user interface 2500 as illustrated in FIG. 25. A home user interface 2500 may display a window 2503 showing a list of tasks assigned to the security analyst currently requiring a response. Tasks may be associated with a particular incident. The window 2503 may include a link allowing a security analyst to quickly be presented with a user interface 800 relating to the particular incident as described previously. The home user interface 2500 may also display a number of incidents currently assigned to the security analyst in another window 2506. The incidents displayed in the window 2506 may be hyperlinks allowing the security analyst to quickly be presented with a user interface 800 relating to each of the particular incidents as described previously.

The home user interface 2500 may also display a window 2509 showing messages mentioning the security analyst. The messages displayed in the window 2509 may be associated with one or more incidents. Each message may include a hyperlink allowing the security analyst to quickly be presented with a user interface 800 in which the message was originally presented.

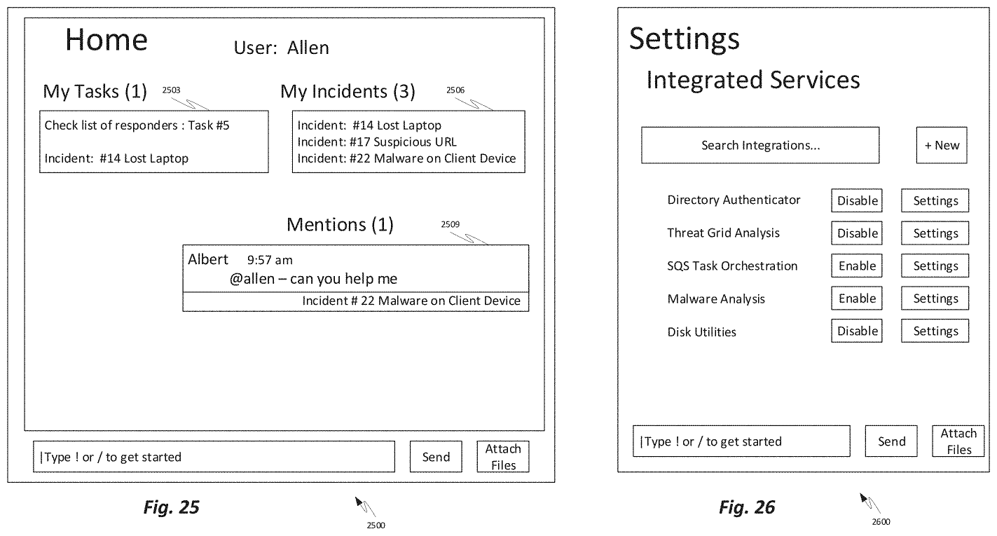

As illustrated in FIG. 26, a security analyst terminal may be capable of presenting a settings window 2600. A settings window may enable a security analyst to enable and/or disable a number of services integrated into the system. Each service may have settings which may be modified by a security analyst using a settings window 2600. The settings window 2600 may allow a security analyst to add a new service to the system or search among the integrated services.

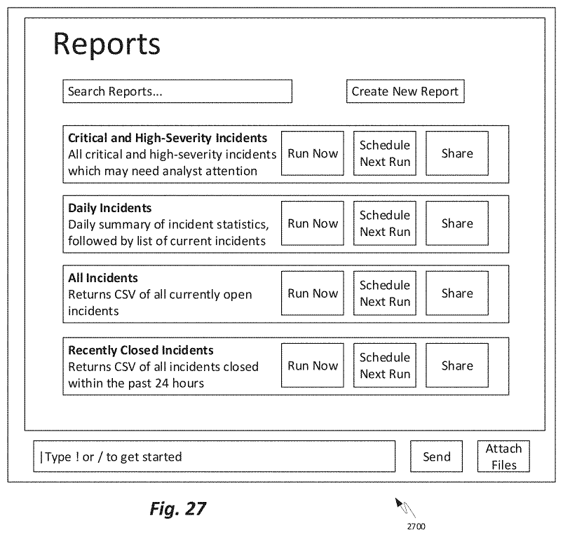

As illustrated in FIG. 27, a security analyst terminal may be capable of presenting a reports user interface 2700. A security analyst may use the reports user interface 2700 to generate and/or schedule reports relating to incidents and incident resolution. For example, reports may be related to one or more of a listing of all critical and/or high-severity incidents which may currently require analyst attention, a list of current incidents with a summary of statistics, a CSV file including information on all currently open incidents, a CSV file including information relating to all incidents closed within a particular timeframe, or other information.

Reports may be run upon a command from a user, scheduled for a particular future date, scheduled for a repeating schedule, or may be shared with other users. The reports user interface 2700 may allow a user to search among the currently existing reports or to create a new report.

Embodiments include a computer program product comprising: a non-transitory computer-readable storage medium having computer-readable program code embodied therewith, the computer-readable program code configured when executed by a processor to: monitor an input to a user interface; based on the input, determine an action to recommend; and display a visualization of the action to recommend on the user interface.

Aspects of the above computer program product include wherein the action to recommend is determined based on past actions by users facing one or more past incidents similar to an incident associated with the user interface.

Aspects of the above computer program product include wherein the user interface is associated with a cyber-security incident.

Aspects of the above computer program product include wherein the input is made by a cyber-security analyst using a cyber-security analyst terminal, wherein the processor monitors the input from a network location.

Aspects of the above computer program product include wherein the input is related to a second cyber-security analyst.

Aspects of the above computer program product include wherein the computer-readable program code is further configured when executed by the processor to: determine the second cyber-security analyst is not associated with the user interface; and based on the determination that the second cyber-security analyst is not associated with the user interface, associate the second cyber-security analyst with the user interface.

Aspects of the above computer program product include wherein the computer-readable program code is further configured when executed by the processor to: after determining the action to recommend, automatically add a user to an investigation associated with the user interface based on the determined action to recommend.

Embodiments include a method comprising: monitoring an input to a user interface; based on the input, determining an action to recommend; and displaying a visualization of the action to recommend on the user interface.

Aspects of the above method include wherein the action to recommend is determined based on past actions by users facing one or more past incidents similar to an incident associated with the user interface.

Aspects of the above method include wherein the user interface is associated with a cyber-security incident.

Aspects of the above method include wherein the input is made by a cyber-security analyst using a cyber-security analyst terminal, wherein a processor monitors the input from a network location.

Aspects of the above method include wherein the input is related to a second cyber-security analyst.

Aspects of the above method include the method further comprising: determining the second cyber-security analyst is not associated with the user interface; and based on the determination that the second cyber-security analyst is not associated with the user interface, associating the second cyber-security analyst with the user interface.

Aspects of the above method include the method further comprising: after determining the action to recommend, automatically adding a user to an investigation associated with the user interface based on the determined action to recommend.

Embodiments include a system comprising: a processor; and a computer-readable storage medium storing computer-readable instructions, which when executed by the processor, cause the processor to perform: monitoring an input to a user interface; based on the input, determining an action to recommend; and displaying a visualization of the action to recommend on the user interface.

Aspects of the above system include wherein the action to recommend is determined based on past actions by users facing one or more past incidents similar to an incident associated with the user interface.

Aspects of the above system include wherein the user interface is associated with a cyber-security incident.

Aspects of the above system include wherein the input is made by a cyber-security analyst using a cyber-security analyst terminal, wherein the processor monitors the input from a network location.

Aspects of the above system include wherein the input is related to a second cyber-security analyst.

Aspects of the above system include wherein the computer-readable instructions, when executed by the processor, further cause the processor to perform: determining the second cyber-security analyst is not associated with the user interface; and based on the determination that the second cyber-security analyst is not associated with the user interface, associating the second cyber-security analyst with the user interface.

The illustrative systems and methods of this invention have been described in relation to a security operation platform. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the illustrative embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

For example in one alternative embodiment, the data stream reference module is applied with other types of data structures, such as object oriented and relational databases.

In another alternative embodiment, the data stream reference module is applied in architectures other than contact centers, such as workflow distribution systems.

In yet another embodiment, the systems and methods of this invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Illustrative hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A computer program product comprising:
a non-transitory computer-readable storage medium having computer-readable program code embodied therewith, the computer-readable program code configured when executed by a processor to:
monitor an input to a user interface;
based on the input, determine an action to recommend; and
display a visualization of the action to recommend on the user interface.

2. The computer program product of claim 1, wherein the action to recommend is determined based on past actions by users facing one or more past incidents similar to an incident associated with the user interface.

3. The computer program product of claim 1, wherein the user interface is associated with a cyber-security incident.

4. The computer program product of claim 3, wherein the input is made by a cyber-security analyst using a cyber-security analyst terminal, wherein the processor monitors the input from a network location.

5. The computer program product of claim 4, wherein the input is related to a second cyber-security analyst.

6. The computer program product of claim 5, wherein the computer-readable program code is further configured when executed by the processor to:
determine the second cyber-security analyst is not associated with the user interface; and
based on the determination that the second cyber-security analyst is not associated with the user interface, associate the second cyber-security analyst with the user interface.

7. The computer program product of claim 1, wherein the computer-readable program code is further configured when executed by the processor to:
after determining the action to recommend, automatically add a user to an investigation associated with the user interface based on the determined action to recommend.

8. A method comprising:
monitoring an input to a user interface;
based on the input, determining an action to recommend; and
displaying a visualization of the action to recommend on the user interface.

9. The method of claim 8, wherein the action to recommend is determined based on past actions by users facing one or more past incidents similar to an incident associated with the user interface.

10. The method of claim 8, wherein the user interface is associated with a cyber-security incident.

11. The method of claim 10, wherein the input is made by a cyber-security analyst using a cyber-security analyst terminal, wherein a processor monitors the input from a network location.

12. The method of claim 11, wherein the input is related to a second cyber-security analyst.

13. The method of claim 12, further comprising:
determining the second cyber-security analyst is not associated with the user interface; and
based on the determination that the second cyber-security analyst is not associated with the user interface, associating the second cyber-security analyst with the user interface.

14. The method of claim 8, further comprising:
after determining the action to recommend, automatically adding a user to an investigation associated with the user interface based on the determined action to recommend.

15. A system comprising:
a processor; and
a computer-readable storage medium storing computer-readable instructions, which when executed by the processor, cause the processor to perform:
monitoring an input to a user interface;
based on the input, determining an action to recommend; and
displaying a visualization of the action to recommend on the user interface.

16. The system of claim 15, wherein the action to recommend is determined based on past actions by users facing one or more past incidents similar to an incident associated with the user interface.

17. The system of claim 15, wherein the user interface is associated with a cyber-security incident.

18. The system of claim 17, wherein the input is made by a cyber-security analyst using a cyber-security analyst terminal, wherein the processor monitors the input from a network location.

19. The system of claim 18, wherein the input is related to a second cyber-security analyst.

20. The system of claim 19, wherein the computer-readable instructions, when executed by the processor, further cause the processor to perform:
determining the second cyber-security analyst is not associated with the user interface; and
based on the determination that the second cyber-security analyst is not associated with the user interface, associating the second cyber-security analyst with the user interface.
